(19) United States
(12) Patent Application Publication
(10) Pub. No.: US 2026/0249456 A1
(43) Pub. Date: Aug. 27, 2026

(54) LLARVA: VISION-ACTION INSTRUCTION TUNING FOR ENHANCED ROBOT LEARNING

(71) Applicant: THE REGENTS OF THE UNIVERSITY OF CALIFORNIA, Oakland, CA (US)

(72) Inventors: Trevor Darrell, Berkeley, CA (US); Dantong Niu, Berkeley, CA (US); Baifeng Shi, Albany, CA (US); Jerome Quenum, San Francisco, CA (US); Giscard Biamby, Oakland, CA (US); Yutong Bai, Albany, CA (US); Yuvan Sharma, San Jose, CA (US)

(21) Appl. No.: 19/547,966

(22) Filed: Feb. 24, 2026

Related U.S. Application Data
(60) Provisional application No. 63/762,318, filed on Feb. 24, 2025.

(51) Int. Cl. B25J 9/16; B25J 15/00

(52) U.S. Cl. CPC B25J 9/163; B25J 9/161; B25J 9/1697; B25J 15/0019

(57) ABSTRACT

A robotic device includes a robot having an end-effector, and a large modality model (LMM) pre-trained on vision-language tasks and fine-tuned on image-visual trace pairs. A method of predicting a next sequence of actions for a robot using a large modality model (LMM) includes receiving, at the LMM, an image input and a language input, using the LMM to predict a next action sequence for a robot having an end-effector, and using the LMM to produce predicted visual traces of the end-effector.

### CROSS-REFERENCE TO RELATED APPLICATIONS

This disclosure is a non-provisional of and claims benefit from U.S. Provisional Patent Application No. 63/762,318, filed Feb. 24, 2025, titled “LLARVA: VISION-ACTION INSTRUCTION TUNING FOR ENHANCED ROBOT LEARNING,” the disclosure of which is incorporated herein by reference in its entirety.

### TECHNICAL FIELD

This disclosure relates to Large Multimodal Models (LMMs), more particularly to LMMs that employs structured prompts to unify robot learning and predict intermediate two-dimensional representations to align vision and action spaces for robot learning.

### BACKGROUND

Recently, instruction-tuned Large Multimodal Models (LMMs), such as InstructBLIP (instruction-tuned Bootstrapping Language-Image Pre-training), Instruct-GPT (Instruction Generative Pre-trained Transformer), LLaVA (Large Language and Vision Assistant), PALM (Pathways Language Model) and others have demonstrated state-of-the-art performance on a variety of vision-and-language tasks. However, existing LMMs for robotics do not always demonstrate the same success and consistency across various embodied settings. This may result from the unique challenges encountered in robotics, such as the variability of real-world environments, the differences between robots, and the need to control actions reliably. Since LMMs have been proven to be successful in part due to multimodal instruction tuning, it is natural to leverage this technique in a robotics setting as well.

### BRIEF DESCRIPTION OF THE DRAWINGS

FIG. 1 shows an overview of an embodiment of Large LAnguage model for Robotic Vision and Action (LLARVA).

FIG. 2 shows a diagram of an embodiment of LLARVA.

FIGS. 3A-3E shows visualizations of ground truth and predicted 2-D visual trace after downstream tasks fine-tuning.

FIGS. 4A-4L shows graphical representations of emergent properties of an embodiment of LLARVA.

FIG. 5 shows a chart of data distribution used in training.

FIGS. 6A-6D shows examples from a constructed vision-action tuning dataset.

FIG. 7 shows a setup for a real robot used for evaluating an embodiment of LLARVA.

### DETAILED DESCRIPTION OF THE EMBODIMENTS

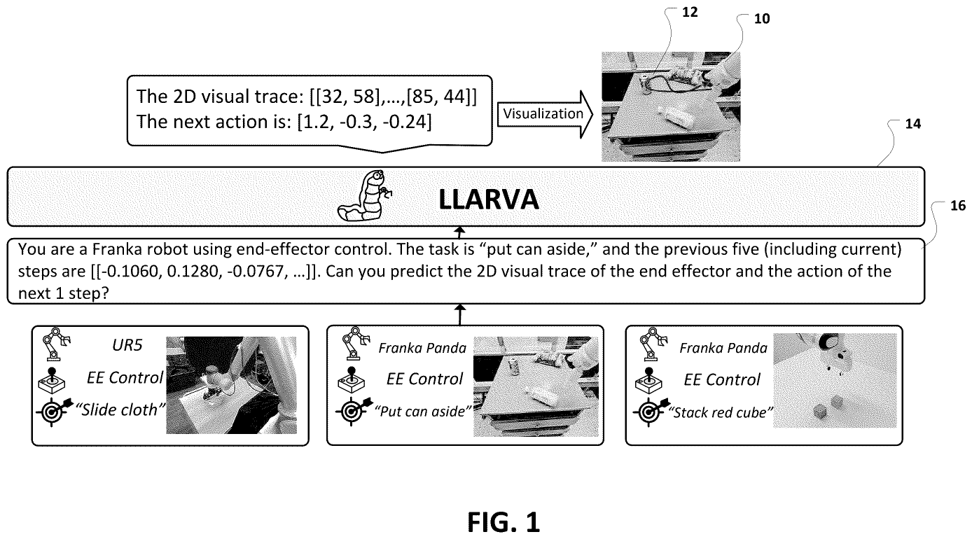

The embodiments herein introduce the Large LAnguage model for Robotic Vision and Action (LLARVA), an opensource instruction-tuned Large Multimodal Model (LMM) for robotic applications that can generalize efficiently across various environments and robotic configurations. The embodiments provide a formulation of a novel instruction prompt that encapsulates robot type, task, scene configuration, and control regime in a natural language prefix amenable to contemporary LMMs. The embodiments present an instruction tuning procedure tailored to the robotic domain. When given an instruction that describes the robot model, control mode, robot task, and proprioceptive information, the model needs to predict future actions given the natural language prompt. This architecture allows the embodiments to leverage structured language prompts as a “lingua franca” for robotic perception and control, as shown in FIG. 1.

In FIG. 1, robot 10 with end-effector 12 operates based upon outputs received from LLARVA 14. The robot will include one or more processors that execute the code that comprises the LLARVA model 14. An example prompt 16 results in the action shown in the middle photograph of the bottom row.

Aligning vision and action modalities to produce meaningful robotic outputs is still not a trivial task. Though recent robotic models have used 3-D representations such as voxels and point clouds to overcome this, these representations are difficult to incorporate into most existing open-source LMMs because they typically accept a single image plus language as input. For these reasons, 2-D images were used, which are easy to scale and integrate with existing LMMs.

It was found that predicting an intermediate 2-D representation, which referred to as visual traces, can help align the vision and action spaces across different robot and task configurations. In particular, the process generates the 2-D visual trace (projection) of an end-effector and force the model to predict this trace alongside the next robot action(s). This waypoint prediction helps align each robotic action to the end-effector's location, allowing the model to focus on fine-grained localization and resulting in a more accurate prediction of robot actions. To achieve this, instructions are constructed with such visual traces using the Open X-Embodiment dataset (OXE), carefully categorizing the action space, the robot type, and the control type.

Through empirical study, the embodiments show that the vision-action instruction tuning approach using structured prompts leads to generalization across various robot environments and configurations. Additionally, the embodiments demonstrate that predicting visual traces can help further align vision and action spaces. LLARVA was evaluated on 18 different tasks in RLBench's simulated environment and on picking, stacking, and destacking tasks with a real 7DoF Franka Emika Panda robot. Finally, the model's generalization was evaluated across two robots in RLBench on four tasks. It is shown that LLARVA—using 2-D and language representations—performs well compared to several contemporary baselines.

LMMs are designed to handle multiple data modalities simultaneously, such as images and their corresponding text descriptions. Each modality is encoded into a shared embedding space, which is then utilized for reasoning by a language model f parameterized by θ. Specifically, an image is encoded using a pre-trained visual encoder, denoted as v parameterized by φ. A corresponding text description is tokenized and encoded using a fixed language encoder e parameterized by γ. Given an input image o and a language task description l, the language model generates a text response R as follows: R=f_{θ}(v_{φ}(o), e_{γ}(l)).

The embodiments here use an LMM within the context of robotic episodes, which are characterized by temporal sequences of visual observations o_{1:N} and proprioceptive states S_{1:N}. Here, N denotes the length of an episode. Notably, in the realm of LMMs for robotics applications, the output R typically encompasses one or more predicted actions for an episode.

Visual traces play a key aspect in the vision-action instruction methodology. The choice of 2-D traces is made to match the high availability of image-based large robotics datasets such as OXE, but the methods herein can also be implemented with 3-D data. To achieve alignment between visual inputs and robotic actions, the processes predict visual traces as an auxiliary task, as it has been found that this helps to gain better fine-grained localization, resulting in a more accurate prediction of robot actions.

The discussion here defines 2-D Visual Traces as a sequence of coordinates (x, y) in a two-dimensional space, which is aligned with the input image oₜ at time step t. These coordinates represent the trajectory of the gripper (or end-effector, hand, etc.) throughout the episode. The visual trace at timestep t is:

$${𝒫}_{t : N} = ( {x}_{i} , {y}_{i} ) \vert i = t , t + 1 , … , N \qquad ( 1 )$$

Here, (xᵢ, yᵢ) denotes the i-th coordinate in the entire visual trace for the episode, and N represents the number of time steps in the episode. One should note that language model decoders are crucial in converting multimodal inputs into actionable outputs in robotics. By leveraging the shared vision-action embedding space, the decoder produces responses that the robotic system can use.

The input to the LLARVA architecture comprises two components. First, the visual observation oₜ, an image captures the state of the environment at timestep t. Second, it has the language instruction input lₜ, which prompts the model to forecast a specified number of subsequent steps, integrating embodied information such as the robot, control mode, and previous proprioceptive states as well as the task directives. Specifically, the method formulates an instruction template featuring the robot type R (e.g., Franka, UR5, xArm), control mode M (e.g., joint or end-effector control, absolute or delta control), task instruction I (e.g., “open the drawer”), proprioceptive information S (e.g., positions or velocities), and a query indicating the number of future actions to predict, denoted as n. The complete instruction is formulated as follows:

lₜ = “You are a [ [symbol] ] robot using [ [symbol] ] control. The task is [I], and the previous [h]steps are [ [symbol] ].
Can you predict the trajectory of the end-effector and the action of the next [n] steps?”

To develop a versatile and adaptive framework capable of accommodating training for tasks with varying time horizons, the process adds flexibility to the proprioceptive information input. Specifically, this information is structured as S=s_{t-h:t}, representing a sequence of past joint and/or gripper states. Here is the number of previous time steps the model is conditioned on and is decided based on the task. This approach ensures robustness and adaptability across a spectrum of task durations, enabling effective training for both short-term and long-term objectives.

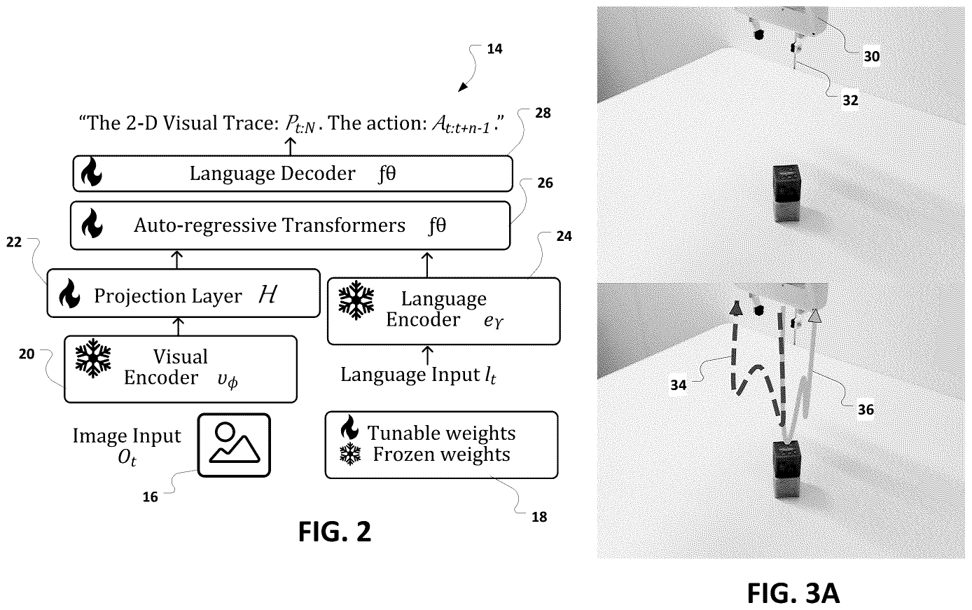

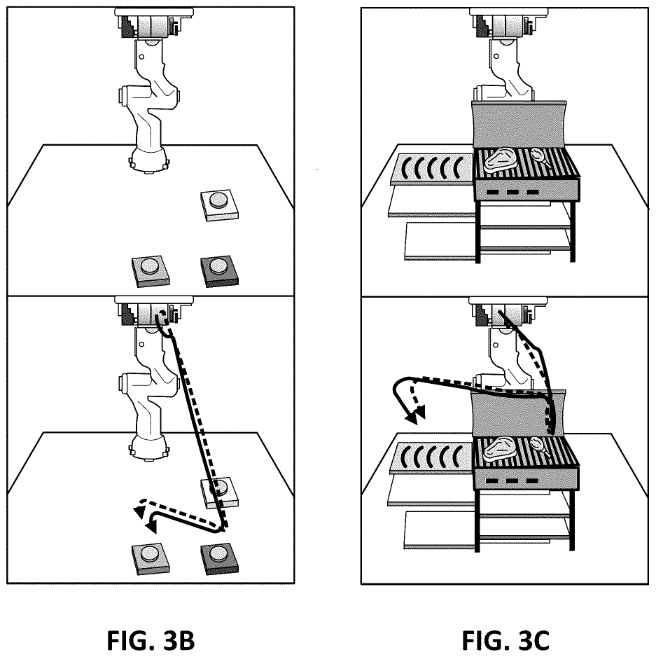

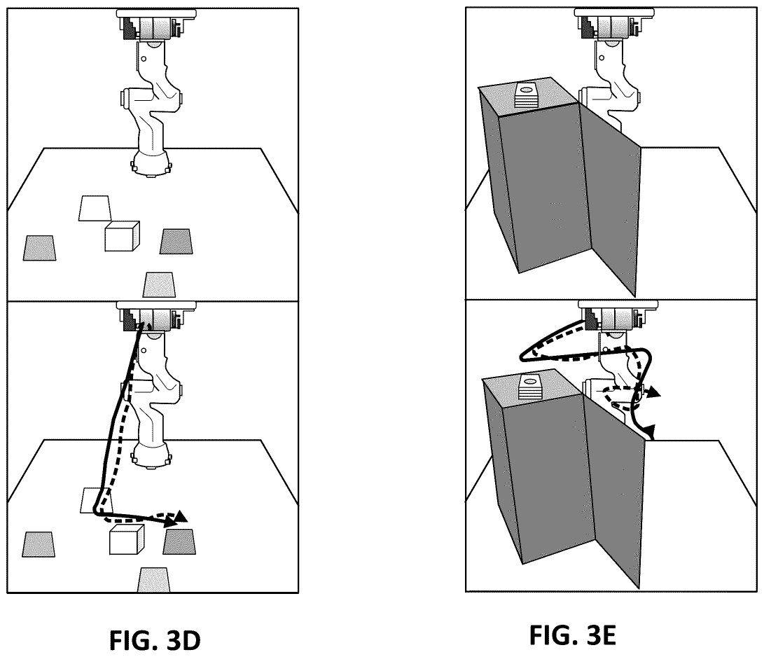

One of the objectives is to develop a large modality model capable of predicting robotic actions that exhibit generalization across a diversity of robotic tasks, scenarios, and environments. The model architecture is illustrated in FIG. 2. As shown in FIG. 2, the inputs to model 14 of FIG. 1 comprise an image input 16 and a language input 18. Visual encoder 20 extracts visual features from the image input to produce visual tokens, and in one embodiment projects those to a Multi-Layer Perceptron (MLP) layer as the projection layer 22. The language encoder 24 tokenizes the language input and the MLP layer aligns the visual tokens with the language tokens. The aligned visual tokens and the language tokens are input to one or more auto-regressive transformers 26. The output of the transformer(s) are then decoded by the language decode 28 and the resulting output comprises a next action sequence 34 of n steps for the robot 30 with a gripper end-effector 32 shown in FIG. 3A.

The instruction-tuned model π is designed to leverage both the current visual observation oₜ and the accompanying language instruction lₜ as input. Subsequently, it predicts the action sequence for the next n steps A_{t:t+n-l} and the future 2-D Visual Traces of the end-effector P_{t:N}, spanning from the current step to the final step within the episode:

$$π ( {o}_{t} , {l}_{t} ) \to {A}_{t : t + n - 1} , {P}_{t : N} \qquad ( 2 )$$

where lₜ is constructed as defined above.

In the pipeline of the embodiments, the input image undergoes processing by the frozen vision encoder v_{φ}(⋅), which extracts visual features and projects into a latent space via an MLP (Multi-Layer Perceptron) layer H. This aligns the visual features with the dimensionality of the language tokens. Simultaneously, the language input undergoes tokenization using a language encoder. The visual tokens and word tokens are then concatenated and fed into the auto-regressive transformers of the LMM f_{θ}, which are trained for next-token prediction.

While keeping the vision encoder and language encoder frozen, instruction tuning was used to train the auto-regressive transformers using standard LoRA (Low-Rank Adapter) for both the pre-training and fine-tuning stages. Each image oₜ for an episode is accompanied by a language instruction lₜ, and the ground-truth annotations consist of robotic actions Â_{t:t+n-l} and visual traces \hat{P}_{t:N}. Next, given oₜ and ₗt, it predicts the next actions and 2-D visual trace. Specifically, for a response R, the probability of the target actions and target visual traces were computed by the following equation:

$$p ( {Â}_{t : t + n - 1} , {\hat{P}}_{t : N} \vert {o}_{t} , {l}_{t} ) = {\prod }_{i = 1}^{\vert R \vert} {p}_{θ} ( {x}_{i} \vert {o}_{t} , {l}_{t} ) \qquad ( 3 )$$

where θ represents the trainable parameters, xᵢ is the current prediction token, and n≤N. To calculate loss, the standard cross-entropy function with these probabilities was used. m

As step 1, the process begins with an LMM that has been pre-trained on vision-language (VL) tasks. To generalize across robotic tasks, scenarios, and environments, the model is pre-trained on the large-scale vision-action instruction dataset. Due to the diversity of this dataset, the model is trained simultaneously for multiple configurations of prompt variables such as robot type R, control mode M, or task instruction I¹. Using language as input allows the bridging of fundamental gaps between subsets brought by these different configurations. This extensive and varied training process can establish a powerful LMM framework that can be further fine-tuned and adapted to handle various robotic settings. It is noted that this pre-training stage is different from standard LMM pre-training. As opposed to aligning the two modalities using a projector in VL, here the two modalities were aligned for generalizing robotic configurations. The LMM resulting from this step may be referred to as an LMM having generalized vision-action alignment.

As step 2, the model is tuned for downstream tasks. Unlike other fields, a robotic model must be fine-tuned on a downstream task before it can be evaluated due to the practical considerations of real-world physical properties. Therefore, the pre-trained model is fine-tuned using a small dataset with a fixed configuration for the factors defined above (e.g., the instruction has the same robot type R, control mode M, etc.). Having seen diverse data samples makes it easy for the model to adapt to specific downstream settings resembling what it has already encountered in pre-training.

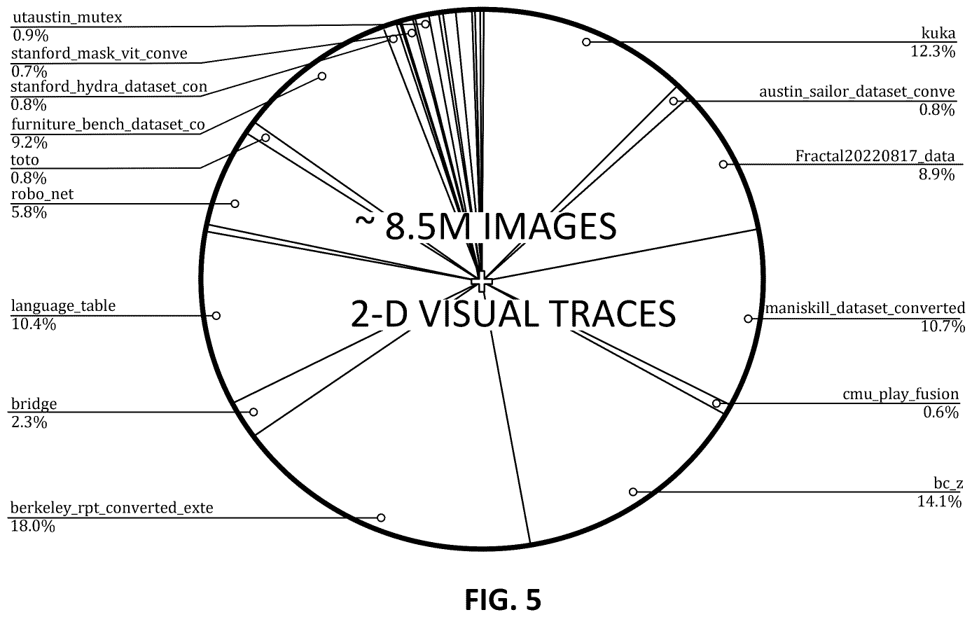

To pre-train LLARVA, 8.5M image-visual trace pairs were generated from the Open X-Embodiment (OXE) dataset. As shown in FIG. 5, the dataset consists of images from a diverse collection of 37 OXE subsets with 13 different robots, including a wide assortment of tasks, environments, cameras, and therefore images, and end-effectors, among other factors. For each image in an episode, the 2-D visual trace of the end-effector P_{t:N} was calculated. For this purpose, the process uses a bounding box detector that is trained specifically on each of the different end-effectors in OXE. The center points of bounding boxes are used for a simpler representation, and the visual trace for step t is then the ordered list of all center points from image t to image N.

LLARVA was evaluated on 12 tasks in RLBench and compared to both existing 2-D and 3-D models. In addition, LLARVA was also tested on a real 7DoF Franka Emika Panda robot.

One embodiment of LLARVA is implemented using PyTorch with the official LLaVA 1.5 implementation. The base LMM uses a Llama 2 7B-parameter LLM, the default image projection layer, and the CLIP ViTL/14 vision encoder. LLARVA was pre-trained, fine-tuned, and evaluated on 8 NVIDIA A6000 GPUs. LLARVA was evaluated using the same 18 RLBench tasks as in M. Shridhar, L. Manuelli, and D. Fox. Perceiver-actor: A multi-task transformer for robotic manipulation. In Conference on Robot Learning, pages 785-799. PMLR, 2023. In the fine-tuning stage, the front view is chosen as oₜ, conditioned on the previous 5 joint positions (i.e., h=5). LLARVA predicts the visual trace and the next action step (i.e., n=1), which is an 8-dimensional vector consisting of 7 joint velocities and a binary gripper state. For evaluation, 25 episodes were taken per task in the validation set and score each episode either 0 for failure or 100 for success. The process uses 5 seeds, which are averaged to get the final success rate.

LLARVA was compared to several baselines using 2-D and 3-D information. Image-BC (CNN) and Image-BC (ViT) are 2-D language-conditioned models that use CNN and ViT vision encoders, respectively, reported in PerAct. The PerAct model uses voxels as 3-D input to calculate actions, as does C2FARM-BC (Course-to-Fine Attention-driven Robotic Manipulation using Behavior Cloning). In contrast to the 3-D line of work, the input uses only one camera view without any 3-D information.

TABLE 1
Success rate (%) on RLBench Multi-Task setting. The pre-trained model was fine-
tuned with visual trace prediction on 12 tasks and evaluated on 25 episodes of each task.

| | Task | | | | | | | | | | | |
|---|---|---|---|---|---|---|---|---|---|---|---|---|
| | | Meat | | | | | | | | | Reach | |
| | Open | off | Turn | Put | Push | Sweep | Slide | Close | Screw | Place | and | Stack |
| Method | drawer | grill | tap | money | buttons | dustpan | block | jar | blub | wine | drag | blocks |

3-D Methods

| | | | | | | | | | | | | |
|---|---|---|---|---|---|---|---|---|---|---|---|---|
| C2FARM- | 20 | 20 | 68 | 12 | 72 | 0 | 16 | 24 | 8 | 18 | 24 | 0 |
| BC | | | | | | | | | | | | |
| PERACT | 80 | 84 | 80 | 44 | 48 | 56 | 72 | 60 | 24 | 12 | 68 | 36 |

2-D Methods

| | | | | | | | | | | | | |
|---|---|---|---|---|---|---|---|---|---|---|---|---|
| Image- | 4 | 0 | 8 | 4 | 0 | 0 | 4 | 0 | 8 | 4 | 0 | 0 |
| BCC | | | | | | | | | | | | |
| (CNN) | | | | | | | | | | | | |
| Image- | 0 | 0 | 1+ | 0 | 0 | 0 | 0 | 0 | 1+ | 0 | 0 | 0 |
| BCC(ViT0 | | | | | | | | | | | | |
| LLARVA | 60 | 80 | 56 | 44 | 56 | 84 | 100 | 28 | 8 | 12 | 52 | 0 |

Table 1 shows results for 12 of the tasks with additional long-horizon task results (such as those with multiple steps or subtasks). The model completely outperforms other 2-D based methods: achieving an average success rate of 43.3%, while Image-BC (CNN) and Image-BC (ViT) both achieve 1.3%. In addition, LLARVA competes with and even beats 3-D based methods, like C2FARM-BC, which averages 22.7%, and PerAct, which achieves 55.3%. One should note that 2-D methods here also include those that use multiple input images from different camera views, while LLARVA uses only one camera view and still displays strong performance. Moreover, it can be observed that despite some cases of occlusion that arise from using just one camera view, LLARVA can still succeed in such situations, showing the adaptability of the model.

Following the setting in I. Radosavovic, B. Shi, L. Fu, K. Goldberg, T. Darrell, and J. Malik. Robot learning with sensorimotor pre-training. In Conference on Robot Learning, pages 683-693. PMLR, 2023 (RPT), the model uses a 7-DoF Franka Emika Panda robot with the default 1-DoF parallel jaw gripper. The input image of comes from the right side RGB camera. LLARVA was evaluated on three tasks: “pick cube,” “destack cube” and “stack cubes.” During fine-tuning, the process uses a comparable number of episodes as RPT for each task, both with/without visual trace joint training. The model was conditioned on joint positions of the previous 16 steps and predict and execute 7-dimensional delta joint positions and 1-dimensional gripper status for the following 16 steps. Sixteen episodes were used to evaluate RPT and LLARVA, 10 episodes for Octo, which is an open-source generalist robot policy, averaging 5 times to get the final success rate.

LLARVA was compared with RPT and Octo, both of which claim the benefit that pre-training brings to the downstream tasks. RPT uses BERT-like (Bi-directional Encoder Representation from Transformers) formulation and must additionally pre-train on in-domain data, while Octo is pre-trained on the mixed dataset OXE and maps the various configurations to the same action space. In contrast, LLARVA is pre-trained in a more diverse manner, without imposing a single action space, via a unified language template.

TABLE 2
Success rate (%) of LLARVA on a real robot. LLARVA is compared
with RPT and Octo by taking each pre-trained model and
fine-tuning them on the same set of demonstrations.

| | 2-D Visual | | | |
|---|---|---|---|---|
| Method | Trace | Pick | Task Stack | Destack |
| RPT | — | 87.50 | 31.25 | 93.75 |
| Octo | — | 60.00 | 10.00 | 40.00 |
| LLARVA | X | 81.25 | 50.00 | 87.50 |
| LLARVA | YES | 93.75 | 56.25 | 100 |

Table 2 shows the results. LLARVA achieves the highest success rate across all the tasks. Additionally, compared to RPT, LLARVA only needs one unified pre-trained model that is first instruction-tuned on the dataset and then fine-tuned on each downstream task. In contrast, RPT needs to be separately pre-trained on each individual task before being adapted to them, which brings additional time and computation cost. In addition, Octo has difficulties adapting to a downstream task using different control modes due to the model never encountering joint position control in the pre-training stage. LLARVA shows better quality both in terms of efficiency for adapting to downstream tasks and compatibility/generalization with different control modes.

To align the vision and action spaces, the end-effector's visual traces were predicted, which forces the model to develop a more comprehensive understanding. FIG. 3A shows through visual traces that the model can plan alternative yet correct paths. In FIGS. 3A-3E, the dashed line 34 in FIG. 3A represents the predicted 2D visual trace, and the solid line 36 indicates the ground truth, which is the same for following figures. For example, in the top left image of FIG. 3A, the gripper end-effector 32 takes a different path (go left) than the ground truth (go right), yet it still succeeds in destacking the cube. FIGS. 3A-E also show qualitatively that the visual trace can help with long-horizon tasks by acting as a memory buffer that compensates for the limited number of previous robotic states the model can handle. For instance, in the bottom right image in FIG. 3B, the task is “push maroon button, then push green button.” The visual trace helps the model reach the “green button” after finishing the first subtask.

The instruction mentioned above was used in pre-training to evaluate its effect. Table 3 shows that the model can achieve an average improvement of 17.5% across the four tasks regardless of visual traces. This improvement may be due to their diverse, large-scale pre-training, which leverages language instructions to create a strong robotics LMM backbone that can successfully adapt to downstream robotic settings.

TABLE 3A
The effect of the instruction pre-training and 2-D visual trace.
The instruction pre-training step (step 1 above) and the visual
traces for four random tasks in RLBench were ablated.

| | | Task | | | |
|---|---|---|---|---|---|
| Instruction | 2-D Visual | reach and | | meat off | slide |
| Pre-training | trace | drag | place wine | grill | block |
| X | X | 40 | 8 | 36 | 48 |
| | YES | 48 | 12 | 40 | 76 |
| YES | X | 44 | 4 | 56 | 80 |
| | YES | 52 | 12 | 80 | 100 |

TABLE 3B
Evaluation across different robots. The success rate (%) of four
randomly chosen tasks in RLBench. Us the same training recipes,
the model was fine-tuned with visual trace but different robots.

| | Task | | | |
|---|---|---|---|---|
| Robot | Sweep dustpan | Put money | Push buttons | Meat off grill |
| Franka | 84 | 44 | 56 | 80 |
| Sawyer | 80 | 48 | 48 | 72 |

To test the importance of the visual traces, the model was fine-tuned with and without the visual trace prediction task. Tables 3A-B show that the traces provide a 15% average improvement across the four tasks. An improvement can be seen in tasks with frequent occlusion of objects such as “meat off grill” in FIG. 3C and “slide block” in FIG. 3D. It is noted that using both pre-training and 2-D visual traces can help the model complete the task even when the target object is not visible. The “put money on top shelf” example in FIG. 3E demonstrates this: the shelf is not visible, and the gripper becomes occluded once it moves behind the counter.

To evaluate LLARVA's generalization across different robots, four tasks were randomly selected RLBench, and finetuned and evaluated on Sawyer instead of Franka Emika Panda. As shown in Table 3B, LLARVA achieves similar results across both robots, which further proves the generalization brought by the large-scale vision-action instruction pre-training.

LLMs are typically pre-trained on a large corpus of text with an unsupervised training objective of next-word prediction. Instruction tuning (IT) helps to bridge the gap between the language model's fundamental pre-training objective of next-word prediction and the user's goal of having the model perform specific tasks using input-output pairs whose inputs include text phrased as instructions. Flamingo, GPT-4, and BLIP were pioneering early LMMs, and LLAVA prompted GPT-4 with image-caption pairs to generate multimodal instruction tuning data. Many recent VL models have followed this approach, as it has been shown to improve generalization in zero-shot and few-shot tasks. Unlike these works, instructions were constructed here from a custom template that is filled in with relevant information about the robotic episode. The instructions capture the time-based nature of robotic episodes by allowing the model to predict the next action based on previous robotic states.

Recent language-conditioned models for robotics have tried different approaches, such as generative video pre-training (GR-1), tokenized voxels for incorporating 3-D information (PerAct), co-training on internet-scale VL data (RT-2), and large-scale diverse pre-training with a transformer architecture (Octo). However, each approach has distinct drawbacks that are attempted to address in the model. For instance, GR-1 requires architectural changes to account for different action spaces when fine-tuning, while LLARVA is more flexible and does not need such changes. Moreover, PerAct relies on 3-D information unavailable on a large scale across environments, which is why 2-D images were chosen when implementing the model. RT-2 uses co-training on a separate web-based dataset, while it more efficiently uses instruction-tuning on a smaller, diverse vision-action instructions dataset to create a strong backbone. Lastly, Octo uses a specialized head to predict actions, while the language head in the model here is trained to predict both robotic actions and visual traces in “natural” language; this is made possible by using language instructions as a unified way to generalize across various robotic settings.

Trajectory modeling has been a fundamental aspect of many machine vision applications. Many previous works have investigated the use of object representations for trajectory modeling, ranging from classical image understanding tasks to an object-centric approach for video understanding with object tracking and interactions to even scene graphs. More recently, there has been an increased interest in trajectory modeling effectiveness for vision and language, such as the referring expression localization task and semantic segmentation using text prompts. In particular, the localized narrative dataset enabled a new task that aims to align a long and detailed image caption to a human trajectory. The work here takes a different approach as the model uses LMMs to exploit the concept of a 2-D visual trace for implicit end-effector object representation.

The below discussion provides more information about the model's emergent properties, the constructed dataset, and implementation details.

TABLE 4
Success rate (%) on RL Bench Multi-Task setting. The pre-trained model was fine-
tuned with visual trace prediction on 18 tasks and evaluated on 25 episodes per track. Each
evaluation episode was scored either 0 for failure or 100 for success. Grayed out methods
included 3-D information.

| | Task | | | | | | | | |
|---|---|---|---|---|---|---|---|---|---|
| | Open | Meat | Turn | Put | Push | Sweep | Slide | Close | Screw |
| Method | drawer | off grill | tap | money | buttons | dustpan | block | jar | bulb |

3-D methods

| | | | | | | | | | |
|---|---|---|---|---|---|---|---|---|---|
| C2FAM- | 20 | 20 | 68 | 12 | 72 | 0 | 16 | 24 | 8 |
| BC | | | | | | | | | |
| PERACT | 80 | 84 | 80 | 44 | 48 | 56 | 72 | 60 | 24 |

2-D methods

| Image- | 4 | 0 | 8 | 4 | 0 | 0 | 4 | 0 | 8 |
|---|---|---|---|---|---|---|---|---|---|
| BC(CNN) | | | | | | | | | |
| Image-BC | 0 | 0 | 16 | 0 | 0 | 0 | 0 | 0 | 16 |
| (Vit) | | | | | | | | | |
| LLARVA | 60 | 80 | 56 | 44 | 56 | 84 | 100 | 28 | 8 |
| | Task | | | | | | | | |
| | | Reach | | | | | | | |
| | Place | and | Stack | Put in | Sort | Insert | Stack | Put in | Place |
| Method | wine | drag | blocks | drawer | shape | peg | cups | cupboard | cups |

3-D methods

| | | | | | | | | | |
|---|---|---|---|---|---|---|---|---|---|
| C2FAM- | 8 | 24 | 0 | 4 | 8 | 4 | 0 | 0 | 0 |
| BC | | | | | | | | | |
| PERACT | 12 | 68 | 36 | 68 | 20 | 0 | 0 | 16 | 0 |

2-D methods

| | | | | | | | | | |
|---|---|---|---|---|---|---|---|---|---|
| Image- | 0 | 0 | 0 | 8 | 0 | 0 | 0 | 0 | 0 |
| BC(CNN) | | | | | | | | | |
| Image-BC | 0 | 0 | 0 | 0 | 0 | 0 | 0 | 0 | 0 |
| (Vit) | | | | | | | | | |
| LLARVA | 12 | 52 | 0 | 0 | 0 | 0 | 0 | 0 | 0 |

LLARVA was evaluated on 18 tasks in RLBench, with the comprehensive results presented in Table 4. LLARVA demonstrates significant improvements over 2-D methods and shows comparable performance to 3-D methods in most tasks. However, for “long horizon” tasks, which are more complex and involve multiple sub-steps or extended durations, LLARVA exhibits similar limitations to other methods. Specifically, for the “place cups” task, where success is defined by placing a specified number of cups on a rack, the experiments reveal that the model often successfully places the first cup but then becomes confused and wanders randomly. As discussed above, while the introduction of 2-D visual traces provides the model with a rudimentary sense of memory, as seen in the “push buttons” example of FIG. 3C, the length of this memory remains limited along the temporal axis. This issue can be partially addressed by incorporating additional conditions that include information from more previous steps; however, it will place greater demands on the maximum context length that vision-language models (VLMs) can handle. Fortunately, several recent works, such as H. Liu, W. Yan, M. Zaharia, and P. Abbeel. World model on million-length video and language with blockwise ring attention. arXiv preprint arXiv: 2402.08268, 2024, have demonstrated promising solutions and performance for VLMs with long context length.

To provide a more comprehensive evaluation of LLARVA, additional tasks in RLBench were explored with specific behavior patterns. The results for 5 additional tasks are presented in Table 5, using the same fine-tuning and evaluation settings as in the main paper. These 5 tasks are categorized into two types: “Bending Task” and “Placement Task”. In “Bending Tasks,” the robot arm is required to grab the target object and move it down to a certain height. LLARVA demonstrates excellent performance on these tasks. In “Placement Task” the robot arm must grab the target object and move it to a pre-specified area. LLARVA performs well overall, except in cases requiring delicate operations during either the “grab” or “place” stages. For example, in the “put knife” task, most failures occur because the gripper misses the thin and delicate handle of the knife. Conversely, in the “put umbrella” task, most failures occur during the “place” stage, as the umbrella stand has a very small hole requiring precise positioning of the gripper during inserting. These issues are primarily due to the lack of detailed information from the visual observation, given that LLARVA uses only a single view image with a 128×128 resolution.

TABLE 5
Evaluation results on more tasks in RLBench. Additional tasks
were explored in RLBench, further categorized into “Bending
Task” in which the robot arm is supposed to grab a
target object then bend and move the target down, and “Placement
Task” in which the robot arm is supposed to grab the
target object, hold and move it to a specified area.

| | Bending Task | | Placement Task | | |
|---|---|---|---|---|---|
| 2-D Visual | Toilet set | Close laptop | Put | Put | Move |
| Trace | down | lid | knife | umbrella | hanger |
| X | 88 | 56 | 36 | 0 | 88 |
| YES | 96 | 68 | 40 | 4 | 68 |

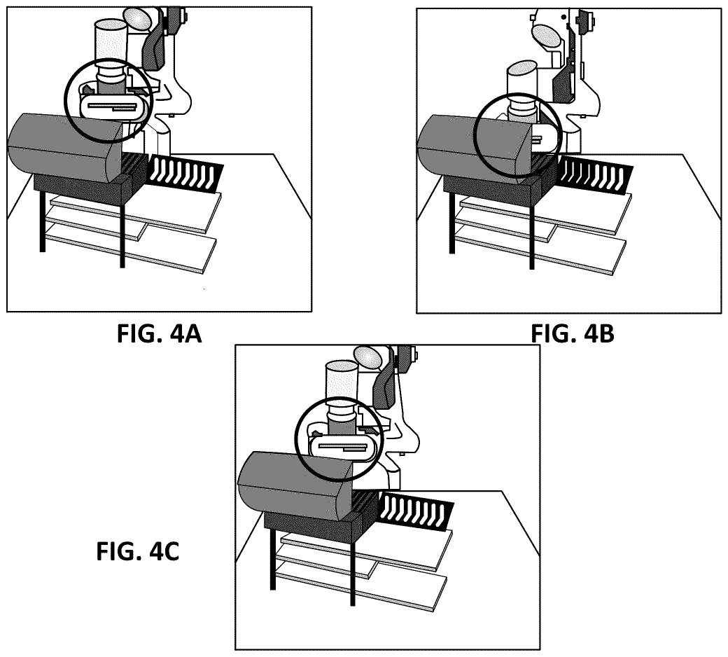

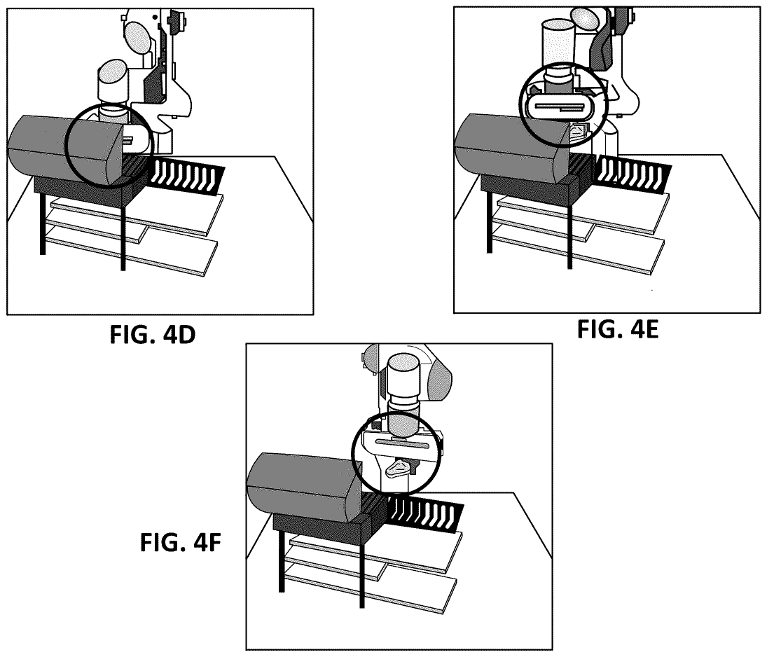

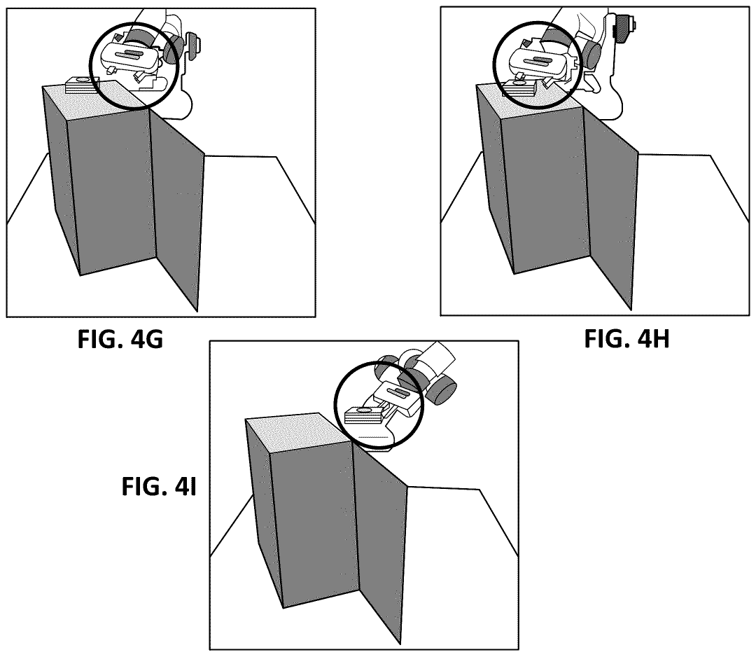

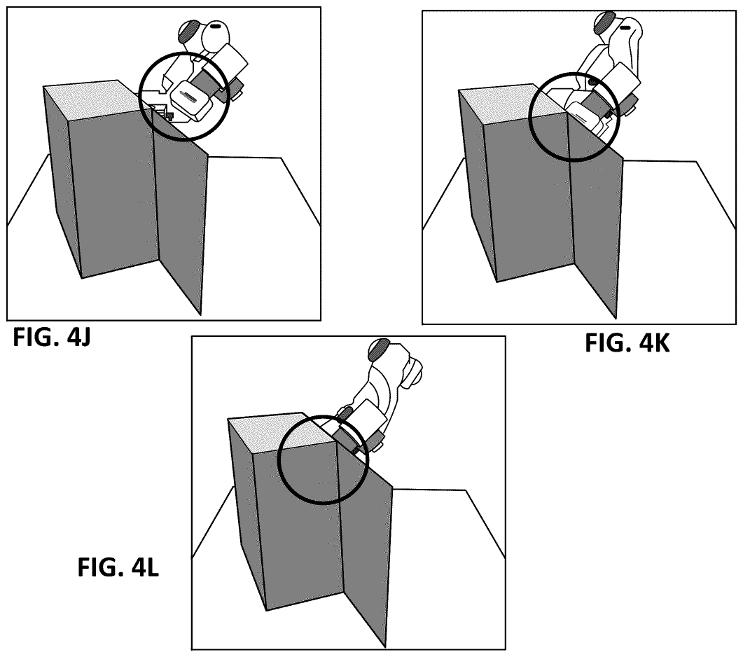

FIGS. 4A-4F show an example of the model failing to pick up an object and then retrying as soon as the end-effector comes back into view without the object in its grasp. Specifically, FIG. 4C represents the moment where the end-effector becomes visible again, and LLARVA then attempts to complete the task again. This behavior emerges from the fact that the instruction prompt fed into LLARVA at this moment is like the prompt at the start of the first attempt, with the main difference being the previous actions/positions included in the prompt. The highlight represents an interesting emergent property since the training data does not include any examples with such behavior.

In both pre-training and fine-tuning stages of LLARVA, only a single camera view was used to provide visual inputs. Using only 2-D inputs creates a challenge since robotics tasks require very accurate action predictions in three dimensions.

The model should be able to see the exact location of the target and have a sense of depth, which other works typically achieve by using either multiple camera views or 3-D representations. It is noted that the model uses a single camera view due to input limitations of current open-source LMMs. These limitations can certainly be overcome and are left for future work.

Using a single camera view presents further challenges when objects in the scene occlude each other. However, it has been found that LLARVA can often complete tasks even in these occluded situations. For example, as shown in FIGS. 4G-4L, the task is “put the money away in the safe on the top shelf”. The camera view only shows the top and back side of the safe, which is enough information to pick up the money from the top of the safe. However, the top shelf of the safe is not visible, and LLARVA can still predict the correct actions to place the stack of money there. This example shows LLARVA can, in some cases, work despite visual obstructions, which is believed to be in part attributable to the introduction of the visual traces. Understanding and predicting the visual trace provides the model with information about a successful end-effector trajectory in the presence of such occlusions.

As mentioned above, the inventors constructed the vision-action tuning dataset from a subset of Open X-Embodiment (OXE). They excluded OXE subsets with poor image quality, smaller image resolution, ambiguous action spaces, or those with widely different robot morphologies, such as Autonomous Mobile Robots (AMRs, which involve locomotion), resulting in 8.5M image-text pairs, whose distribution is shown in FIG. 5 and Table 6. Overall, it was ensured that the resulting dataset contains subsets of OXE that use end-effector control and joint control, in addition to including both absolute and delta control modes.

TABLE 6
More statistics about the vision-action instruction tuning dataset.

| | Number of Image + 2D |
|---|---|
| OXE Subset | visual trace pairs |
| kuka | 1044466 |
| austin_sailer_dataset_converted_externally_to_rlds | 70758 |
| Fracal 20220817_data | 753647 |
| maniskill_dataset_converted_externally_to_rlds | 909568 |
| cmu_play_fusion | 47115 |
| bc_z | 1198963 |
| berkeley_rpt_converted_externally_to_rlds | 1522451 |
| bridge | 195745 |
| language_table | 885876 |
| stanford_kuka_multimodal_dataset_converted_externally_to_rlds | 30128 |
| robo_net | 496454 |
| toto | 65527 |
| furniture_bench_datatset_converted_externally_to_rlds | 786692 |
| stanford_hydra_dataset_converted_externally_to_rlds | 72160 |
| ucsd_pick_and_place_dataset_converted_externally_to_rlds | 13545 |
| kaist_nonprehensile_converted_externally_to_rlds | 6512 |
| stanford_mask_vit_converted_externally_to_rlds | 57012 |
| utokyo_pr2_opening_fridge_converted_externally_to_rlds | 2276 |
| berkely_fanue_manipulation | 11854 |
| utaustin_mutex | 72461 |
| taco_play | 47780 |
| berkeley_autolab_ur5 | 19621 |
| austin_sirius_dataset_converted_externally_to_rlds | 56101 |
| columbia_cairlab_pusht_real | 5486 |
| stanford_robocook_converted_externally_to_rlds | 22894 |
| roboturk | 37120 |
| berkeley_cable_routing | 7797 |
| nyu_franka_play_dataset_converted_externally_to_rlds | 9118 |
| jaco_play | 15515 |
| viola | 15146 |
| tokyo_u_lsmo_converted_externally_to_rlds | 2398 |
| austin_buds_dataset_converted_externally_to_rlds | 6771 |
| dlr_sara_pour_converted_externally_to_rlds | 2695 |
| utokyo_xarm_pick_and_place_converted_externally_to_rlds | 1381 |
| utokyo_pr2_tabletop_manipulation_converted_externally_to_rlds | 6545 |
| Dlr_edan_shared_control_converted_externally_to_rlds | 746 |
| Dlr_sara_grid_clamp_converted_externally_to_rlds | 1543 |

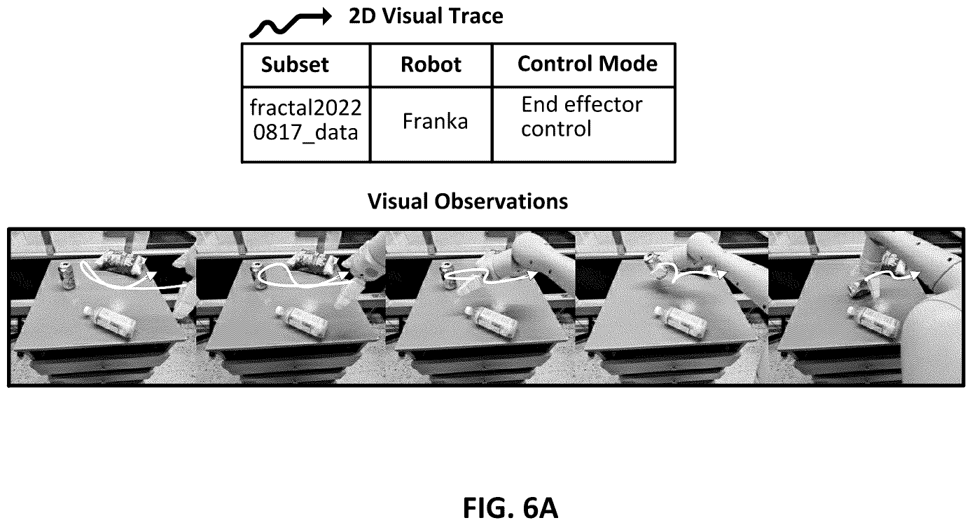

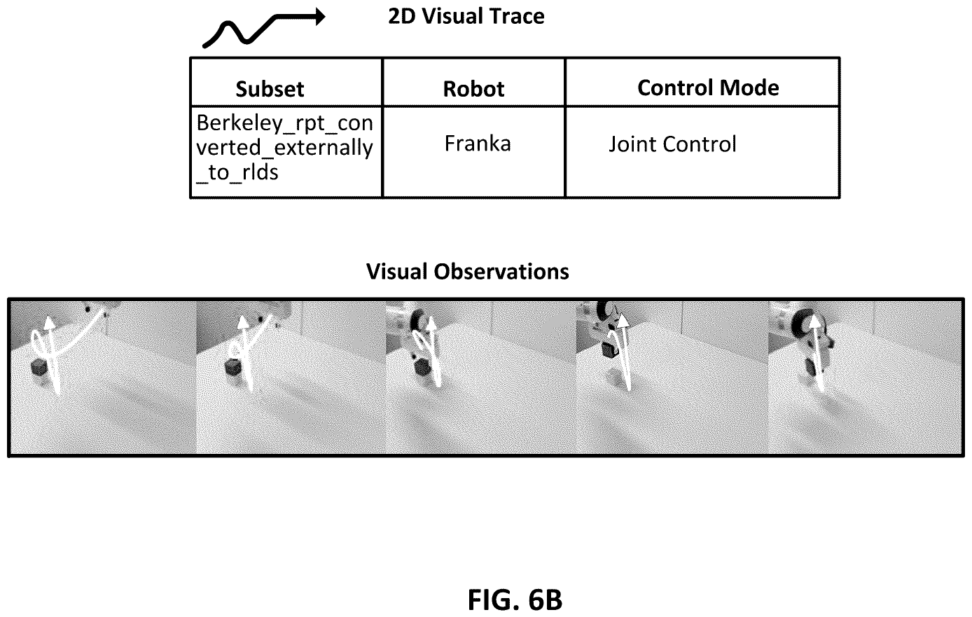

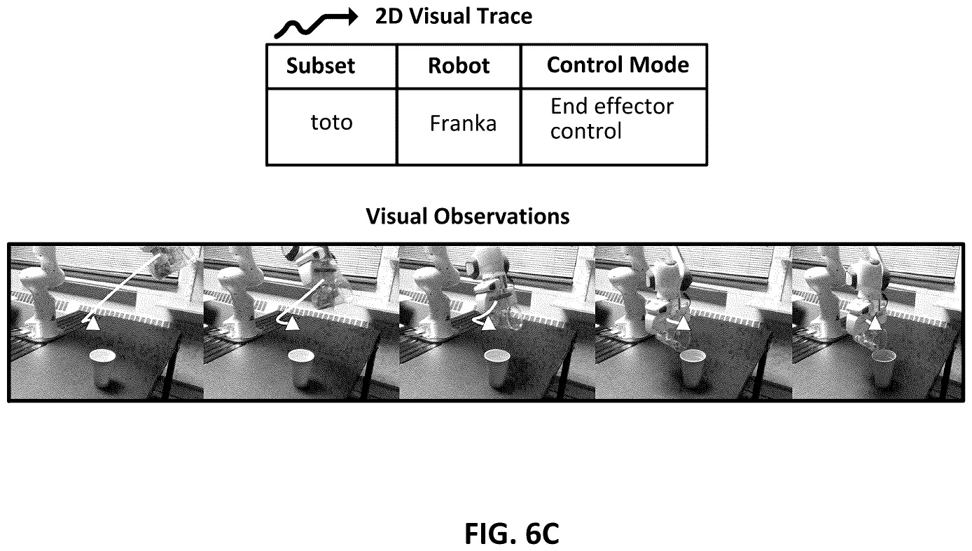

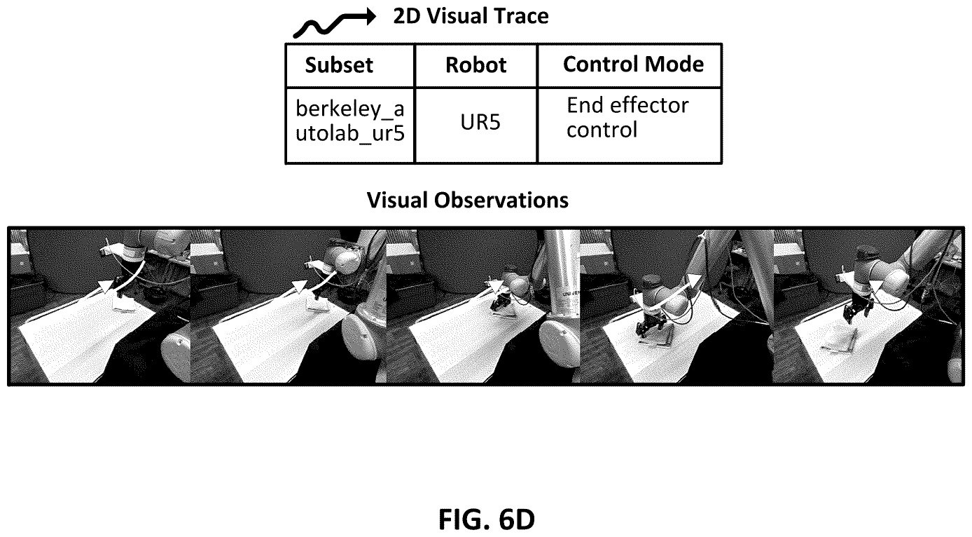

The 2-D visual traces can be seen as a trace of the end-effector location in the image plane across time. To generate these traces, an object detector was trained to locate the end-effector from input 2-D images. The Detectron2 implementation of Faster RCNN (Region-based Convolutional Neural Network) was used to obtain bounding boxes enclosing the end-effector and then use the center point of the bounding boxes as the end-effector keypoint. The detector was trained using 200 manually annotated images from each OXE subset. Some examples of the resulting detector training set are shown in FIGS. 6A-6D, where the 2-D visual traces are shown as lines on the images. Note that the traces are a sequence of 2-D coordinates, and FIGS. 6A-6D is a visualization of these sequences. During training, the sequences are predicted in language token space and compared to ground truth.

LLARVA is evaluated on 12 tasks from RLBench. All RLBench tasks include two or more variations of a language instruction describing the goal. For example, there might be three variations of the instruction for the same task: “open the top drawer,” “grip the top handle and pull the top drawer open” and “slide the top drawer open.” For simplicity, only the first instruction was used as a variant for training. Below, the discussion describes the RLBench tasks used for simulator evaluation, along with any modifications made to the tasks. The intention behind the modifications is to increase the variations of the tasks, such as adding distractor objects with different colors. This exercises the model's language grounding abilities. All tasks are unmodified unless otherwise noted.

The process starts with a LLARVA model that has undergone vision-action instruction pre-training on OXE as described above and performs step 2 instruction fine-tuning for four epochs on task-specific downstream data (e.g., picking, stacking, destacking) using eight A100 GPUs. Step 2 instruction tuning is done using 800 demonstrations for each RLBench task. The domain gap between step 1 and step 2 is large as it changes from almost entirely real data to simulation while at the same time changing robots and tasks. It is noted that while other works train on a smaller amount of data, they use roughly the same order of magnitude of data as LLARVA and exploit the power of 3-D representations. For example, PerAct uses 100 examples per task but exploits voxel-based 3-D representations, which are rare and difficult to obtain. The approach has the advantage of being able to leverage 2-D representations, which may require additional data but with roughly the same order of magnitude as methods that utilize 3-D. Below is a list of the tasks.

The Open Drawer task is to open one of three drawers. The success metric is a full extension of the prismatic joint of the target drawer.

The Meat off Grill task is to take either a piece of chicken or steak off the grill and put it on the side. The success metric is the placement of the specified meat on the side, away from the grill.

The Turn Tap task is to turn either the left or right handle of the tap. Left and right are defined according to the orientation of the faucet. The success metric is the joint of the specified handle being at least 90° away from the starting position.

The Put Money task is to pick up the stack of money and place it on the specified shelf of a safe. The safe has three shelves: top, middle, and bottom. The success metric is the placement of the stack of money on the specified shelf in the safe.

The Push Buttons task is to push the colored buttons in the specified sequence. There are always three buttons present in the scene, whose colors are sampled from 20 options, and the number of buttons to press is between one and three. The success metric is all specified buttons being pressed in the right order.

The Sweep Dustpan task is to sweep the dirt particles into the specified dustpan. There are two dustpans, one short and one tall, and both are always present in the scene. The success metric is all five dirt particles being inside the specified dustpan. This task was modified by adding a variation with a different-sized dustpan.

The Slide Block task has a block and four colored squares in the scene (green, blue, pink, and yellow). The task is to slide the block onto either the green or pink squares. The success metric used is some part of the block being on the specified target square. The original task only had one target square and was modified by adding three additional colored squares-one target and two distractors.

The Close Jar task is to screw in the lid on the jar with the specified color. There are always two colored jars in the scene, one target jar and one distractor jar. The success metric used is the lid being on top of the specified jar and the robot gripper not grasping any object. This task was modified so that the target jar color is drawn from a list of two possible colors (blue or teal). The color for the distractor jar was still chosen out of 20 options.

The Screw Bulb task has two bulb holders of different colors, and the task is to pick up a light bulb from the stand specified by color and screw it into the bulb stand. The color of the target holder is sampled from two colors, while the color of the distractor holder is sampled from the original 20 color options. The success metric used is the bulb from the specified holder being inside the bulb stand. This task was changed to use two colors for the target holder (yellow and purple) rather than 20 as in the original task specification.

The Place Wine task is to pick up the wine bottle and place it at the specified location in a wooden rack. The rack has three locations: left, middle, and right. The success metric is the placement of the bottle on the specified location in the rack.

The Reach and Drag task has an environment having a cube, a stick, and four possible colored target squares. The task is to pick up the stick and use it to drag the cube to the target square of a specified color. The other three squares are considered distractors. The success metric used is some part of the block being inside the target's area. This task was modified to sample the target color from a list of three colors (maroon, magenta, teal). The colors for distractor squares are still sampled from 20 options.

The Stack Blocks task has a scene that starts with 8 blocks and a green platform. Four of the blocks are of a target color, and the other four have a distractor color. The task is to stack N blocks of the target color on the green platform. The success metric is N blocks being inside the area of the green platform.

The Put Item in Drawer task has a block kept on top of a chest of closed drawers. The task is to place the block into the specified drawer among three possible options: top, middle, or bottom. The success metric is the placement of the block inside the specified drawer.

The Sort Shape task has a scene having four distractor shapes and one correct shape. The task is to pick up the shape specified in the language instruction and place it in the correct hole in the sorter. The success metric is the correct shape being inside the corresponding hole.

The Insert Onto Square Peg task has a scene with a platform with three differently colored pegs, and one square shaped object with a hole in the middle. The three colors are sampled from 20 color instances. The task is to pick up the square and put it on the peg specified in the language instruction, with the success metric being the placement of the square fully on the peg.

The Stack Cups task has a scene having three cups with colors sampled from 20 options. The task is to stack all cups inside the cup specified in the language instruction. The success metric for this task is all other cups being inside the specified cup.

The Put Groceries in Cupboard task has a scene that always has nine grocery items and one cupboard. The task is to place the item specified in the language instruction inside the cupboard. The success metric used is the placement of the item inside the cupboard.

The Place Cups task has a scene that always has one cup holder with three spokes and three cups with handles. The task is to place N of the cups on the cup holder (N E {1, 2, 3}). The success metric used is the alignment of each cup's handle with a spoke on the cup task.

The Toilet Seat Down task has a scene consisting of a toilet which initially has its seat up. The task is to put the toilet seat down. The success metric used is the joint of the toilet seat being at an angle consistent with the seat being fully down.

The Close Laptop Lid task has a scene consisting of a laptop which initially has its lid open. The task is to close the laptop. The success metric used is the joint of the laptop lid being at an angle such that the screen is fully down.

The Put Knife on Chopping Board task has a scene consisting of a knife inside a knife holder, and a chopping board. The task is to pick up the knife from the holder and place it on the chopping board. The success metric used is the knife being on the surface of the chopping board, and the robot gripper not grasping anything.

The Put Umbrella in Umbrella Stand task has a scene consisting of an umbrella and an umbrella holder. The task is to pick up the umbrella and put it into the stand. The success metric used is the umbrella being inside the stand, and the robot gripper not grasping anything.

The Move Hanger task has a scene consisting of a clothes hanger and two racks. The task is to move the hanger from its current rack to the other rack. The success metric used is the hanger being placed on the other rack.

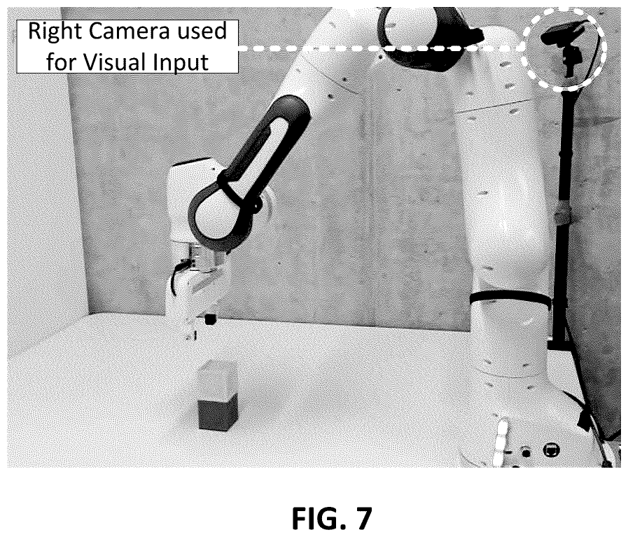

The experimental set up used a Franka Emika Panda robot with a Franka gripper for real robot data collection and evaluations. A Logitech BRIO 4K camera positioned to the right of the Franka robot provides single-view RGB (without depth data) vision input to the model, as shown in FIG. 7. Camera autofocus is disabled, and the data is captured at 640×480 resolution. The model inference is done on a 48 GB NVIDIA A6000.

Data collection uses the data collection code and process from https://github.com/Max-Fu/franka-scripted to collect data for picking, stacking, and destacking tasks. The script generates data for an arbitrary number of episodes. For each episode, the process generates x-y positions on the table plane using a uniform random distribution for each axis. The script directs the robot to place the cube at each location and then collects the camera and joint information as the robot is directed to pick, stack, or destack the cubes. Vision is not used during this process as the cube locations are all generated and therefore known.

The Franka Emika Panda robot experiments were started with the LLARVA model that has undergone vision-action instruction pre-training on OXE as described above and perform step 2 instruction fine-tuning for four epochs on 1920 episodes of task-specific downstream data (e.g., picking, stacking, destacking) using 8 A100 GPUs. This is like other baselines, such as RPT, that uses an equal number of in-domain episodes (1920) for pre-training, with an additional 120-240 episodes used for fine-tuning depending on the task. Additionally, RPT uses three camera views for each episode, while LLARVA uses only one. Nevertheless, it can be observed that LLARVA demonstrates superior performance on all three tasks tested despite using comparable or even fewer episodes. Finally, each real robot evaluation consists of 16 repeated pick, stack, or destack operations at a random x-y location on the table plane for each repetition. The results of the success rate of the 16 operations are shown below.

The proposed model, LLARVA, represents a significant advancement in the application of instruction-tuned LMMs for robotics. By leveraging structured prompts to unify a range of robotic configurations and introducing the concept of visual traces, a generalization method was shown that better aligns vision and action modalities. The extensive training on 8.5M image-visual trace pairs derived from the Open X-Embodiment dataset and evaluation in both simulated and real-world settings highlight the model's superior performance and generalization capabilities compared to existing approaches. This work marks a meaningful step forward in the integration of LMMs with robotics, promising enhanced adaptability and efficiency in various robotic applications.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. The Appendix submitted with this application is incorporated in its entirety herein.

Additionally, this written description refers to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of this disclosure have been illustrated and described for purposes of illustration, it will be understood that various modifications may be made without departing from the spirit and scope of the invention. Accordingly, the invention should not be limited except as by the appended claims.

1. A robotic device comprising:
a robot having an end-effector; and
a large modality model (LMM) pre-trained on vision-language tasks and fine-tuned on image-visual trace pairs.

2. The robotic device as claimed in claim 1, wherein the robot has one or more processors configured to execute code that causes the one or more processors to receive inputs for the LMM, the inputs comprising a language input at a time step and an image input at the time step.

3. The robotic device as claimed in claim 2, wherein the one or more processors are further configured to execute code that causes the LMM to produce an output comprising an action sequence for the end-effector.

4. The robotic device as claimed in claim 2, further comprising a language encoder to receive the language input and tokenize the language encoder to produce word tokens.

5. The robotic device as claimed in claim 4, further comprising a visual encoder to encode the image input to produce visual tokens.

6. The robotic device as claimed in claim 5, wherein the LMM further comprises one or more auto-regressive transformers to receive the word tokens and the visual tokens.

7. The robotic device as claimed in claim 6, wherein the LMM further comprises an output language decoder to convert outputs of the one or more auto-regressive transformers into a predicted action sequence for the end-effector.

8. The robotic device as claimed in claim 5, further comprising a projection layer to which the visual encoder projects the visual tokens to allow alignment to generalized configurations of the robot.

9. The robotic device as claimed in claim 3, wherein the one or more processors are further configured to execute code that causes the LMM to produce an output comprising future visual traces of the end-effector, spanning from a current step to a final step within a training episode.

10. The robotic device as claimed in claim 1, wherein the image-visual trace pairs comprises one of either two-dimensional visual trace pairs or three-dimensional visual trace pairs.

11. A method of predicting a next sequence of actions for a robot using a large modality model (LMM), comprising:
receiving, at the LMM, an image input and a language input;
using the LMM to predict a next action sequence for a robot having an end-effector; and
using the LMM to produce predicted visual traces of the end-effector.

12. The method as claimed in claim 11, further comprising:
training the LMM using a large-scale vision-action instruction data set producing an LMM having generalized vision-action alignment; and
fine-tuning the LMM having generalized vision-action alignment on a downstream task for the robot.

13. The method as claimed in claim 11, wherein using the LMM comprises:
encoding the language input using a language encoder to produce language tokens;
encoding the image input using an image encoder to produce visual tokens; and
using auto-regressive transformers of the LMM to generate next-token predictions for the robot; and
outputting the next-token predictions as the next action sequence.

14. The method as claimed in claim 13, further comprising projecting the visual tokens to a Multi-Layer Perceptron layer to align the visual tokens with the language tokens.

15. The method as claimed in claim 11, wherein the visual traces comprise one of either two-dimensional visual traces or three-dimensional visual traces.
